(19) United States
(12) Patent Application Publication
(10) Pub. No.: US 2025/0366661 A1
(43) Pub. Date: Dec. 4, 2025

(54) GRILL ASSEMBLY THAT INCLUDES FIRE TRAY AND STAND

(71) Applicant: Breeo, LLC, Kinzers, PA (US)

(72) Inventor: Christopher Boehmer, Shohola, PA (US)

(21) Appl. No.: 19/225,812

(22) Filed: Jun. 2, 2025

Related U.S. Application Data
(60) Provisional application No. 63/654,770, filed on May 31, 2024.

(51) Int. Cl. A47J 37/07

(52) U.S. Cl. CPC A47J 37/0731

(57) ABSTRACT

A grill apparatus includes a fire tray removably carried by a stand. When carried by the stand, the fire tray is used for cooking in combination with cooking utensils. When the fire tray is removed from the stand, the fire tray functions as a fire pit that can be used on the ground, on a pad, or on a table. The fire tray is readily removable and replaceable so that the fire tray can be used for cooking, then removed and then used as a fire pit at a different location. The grill provides a slidable connection between the stand and fire tray that allows a user lifts the fire tray up from between a plurality of supports to remove the fire tray from the stand. The fire tray is replaced by reversing this process.

### CROSS REFERENCE TO RELATED APPLICATIONS

This application claims the benefit of U.S. Provisional Patent Application No. 63/654,770 filed May 31, 2024; the disclosures of which are incorporated herein by reference.

### BACKGROUND OF THE DISCLOSURE

### 1. Technical Field

The disclosure generally relates to cooking devices in the nature of fire pits and grills. More specifically, the disclosure relates to the use of a fire pit or fire tray on a stand to function as a multiple-fuel grill. The fire tray portion of the assembly can be readily removed and used separate from the stand as a fire pit and then replaced.

### 2. Background Information

People enjoy cooking outside over a variety of heat sources. Cooking over a traditional campfire fueled with wood is desirable but has challenges such as location, local fire ordinances, and securely positioning cooking implements at the correct levels for desirable cooking temperatures. Multiple-fuel grills are desirable because they can use charcoal for convenience, firewood for heat and flavor, or a combination of both charcoal and firewood. Grills are easier to locate near houses and on decks which can make them more convenient for preparing food.

### SUMMARY OF THE DISCLOSURE

The disclosure provides an apparatus having a fire tray removably carried by a stand. When carried by the stand, the fire tray is used for cooking in combination with cooking utensils. When the fire tray is removed from the stand, the fire tray functions as a fire pit that can be used on the ground, on a pad, or on a table. The fire tray is readily removable and replaceable so that the fire tray can be used for cooking, then removed and used as a fire pit at a different location.

The disclosure provides an exemplary configuration wherein a user lifts the fire tray up from between a plurality of supports to remove the fire tray from the stand. The fire tray is replaced by reversing this process.

The disclosure provides an exemplary configuration wherein the supports of the stand engage the fire tray below the upper wall of the fire tray. In another configuration, the supports also prevent relative rotation between the fire tray and the stand by extending at least partially around at least one of the legs of the fire tray. In a further configuration, a support extends at least partially around each of the legs of the fire tray.

In an exemplary configuration, the disclosure provides leg boxes at the top of each leg. The leg boxes are received in fire tray support boxes that include a fire tray support. In one embodiment, the fire tray support interacts with a leg of the fire tray. In another embodiment, the fire tray support covers the open top of the hollow leg. In the exemplary embodiment of the disclosure, the fire tray support performs both functions.

The disclosure provides a configuration wherein the stand includes trays that are selectively movable between upright and stored positions.

In one configuration, the fire tray has a removable ash tray positioned above the inner bottom wall of the fire box. The ash tray defines air inlet manifolds. In the exemplary configuration, the air inlet manifolds define a plurality of air inlet openings along the bent corners between the sidewalls and top wall of the manifold arms. The air inlet openings are thus raised to minimize clogging.

In one configuration, a movable handle is carried by the ash tray.

In one configuration, the bottom wall of the fire tray defines a drain opening.

In another configuration, the fire tray has airflow channels defined by its sidewall so that heated air is delivered to the top of the fire box to increase combustion and decrease smoke produced by the grill.

In another configuration, the fire tray includes legs that allow it to be used on its own when removed from the stand. The legs extend to a distance lower than the heat shield of the fire tray so that the heat shield and airflow inlets are positioned above a generally flat support surface on which the fire tray is being used as a fire pit.

The disclosure provides a fire tray having an inner sidewall that tapers inwardly or has a decreasing diameter as it approaches the bottom wall. The decreased diameter near the bottom wall allows the ash tray to engage the inner sidewall and be supported while being small enough to be lifted out of the fire tray without interference from the portion of the upper wall that overhangs the fire box.

The preceding non-limiting aspects of the disclosure, as well as others, are more particularly described below. A more complete understanding of the devices, assemblies, and methods can be obtained by reference to the accompanying drawings, which are not intended to indicate relative size and dimensions of the assemblies. In those drawings and the description below, like numeric designations refer to components of like function. Specific terms used in that description are intended to refer only to the particular structure of the embodiments selected for illustration in the drawings, and are not intended to define or limit the scope of the disclosure.

### BRIEF DESCRIPTION OF THE DRAWINGS

FIG. 1 is a perspective view of an exemplary configuration of the fire pit and stand of the disclosure.

FIG. 2 is a front elevation view thereof.

FIG. 3 is a right-side view thereof.

FIG. 4 is a perspective view of four fire tray supports carried by four legs with the trays.

FIG. 5 is a top plan view thereof.

FIG. 6 is a top plan view of the exemplary configuration of FIG. 1.

FIG. 7 is a bottom plan view thereof.

FIG. 8 is a perspective view of the removable fire tray.

FIG. 9 is a top plan view thereof.

FIG. 10 is a side elevation view thereof.

FIG. 11 is a bottom plan view thereof.

FIG. 12 is a perspective view of the outer sidewall.

FIG. 13 is a top plan view of the ring-shaped upper wall of the fire tray.

FIG. 14 is a perspective view of the removable ash tray.

FIG. 15 is a top plan view thereof.

FIG. 16 is a side elevation view thereof.

FIG. 17 is a perspective view of the inner sidewall and bottom wall.

FIG. 18 is a top plan view thereof.

FIG. 19 is a side elevation view thereof.

FIG. 20 shows the accessory post support tube location.

FIG. 21 shows the assembly with the ash tray removed.

FIG. 22 is a perspective view of one of the legs of the stand.

FIG. 23 is an enlarged view of the upper end thereof.

FIG. 24 is a perspective view of one of the fire tray supports.

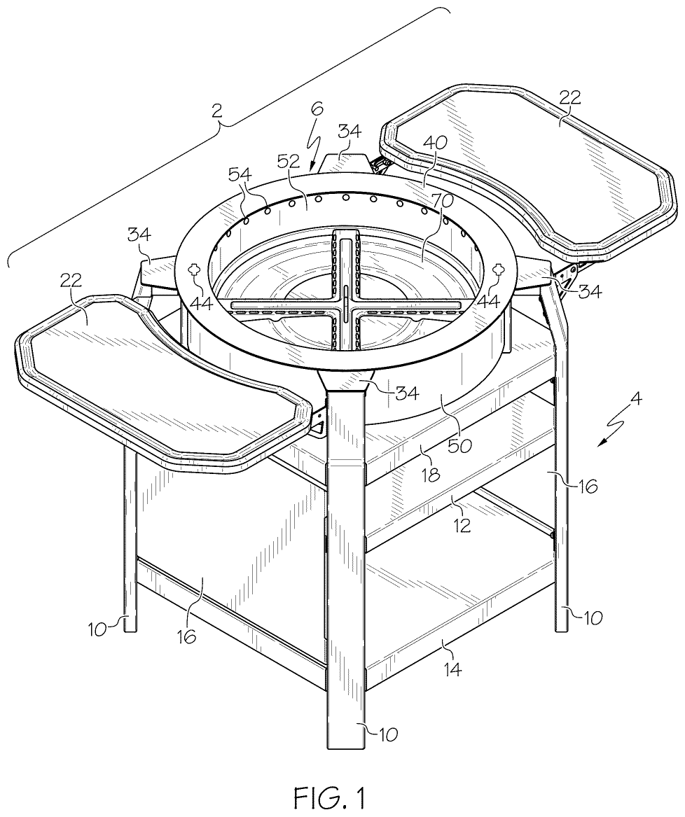

### DETAILED DESCRIPTION OF THE DISCLOSURE

This description of exemplary embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

An exemplary configuration of the fire pit and stand apparatus is indicated generally by the number 2 in the drawings. Apparatus 2 includes a stand 4 and a removable fire tray 6. When carried by stand 4, fire tray 6 is used for cooking by itself or in combination with cooking utensils. When removed from stand 4, fire tray 6 is used as a fire pit. Fire tray 6 can be placed on the ground, on a heat-resistant pad or other heat resistant material or materials, or on a table. Fire tray 6 includes its own legs 8 (see FIG. 8) that provide support when it is used as a stand-alone fire pit.

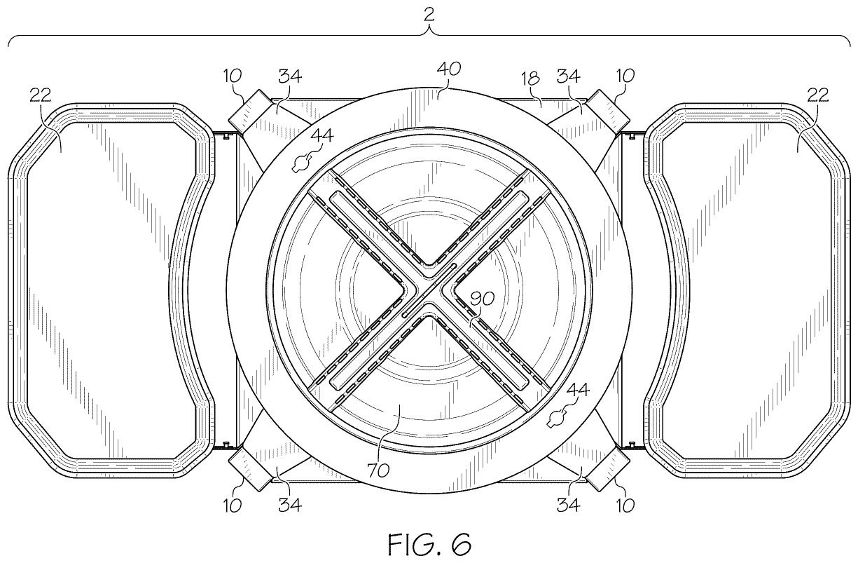

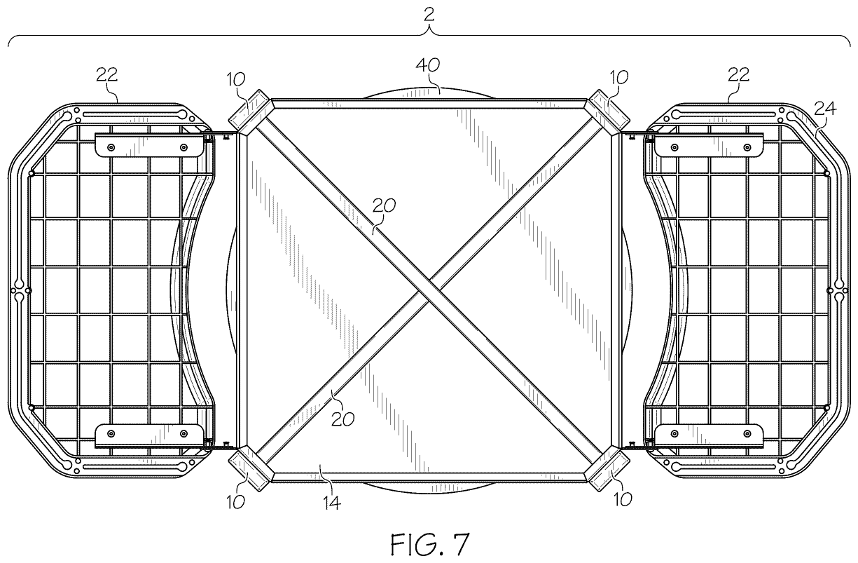

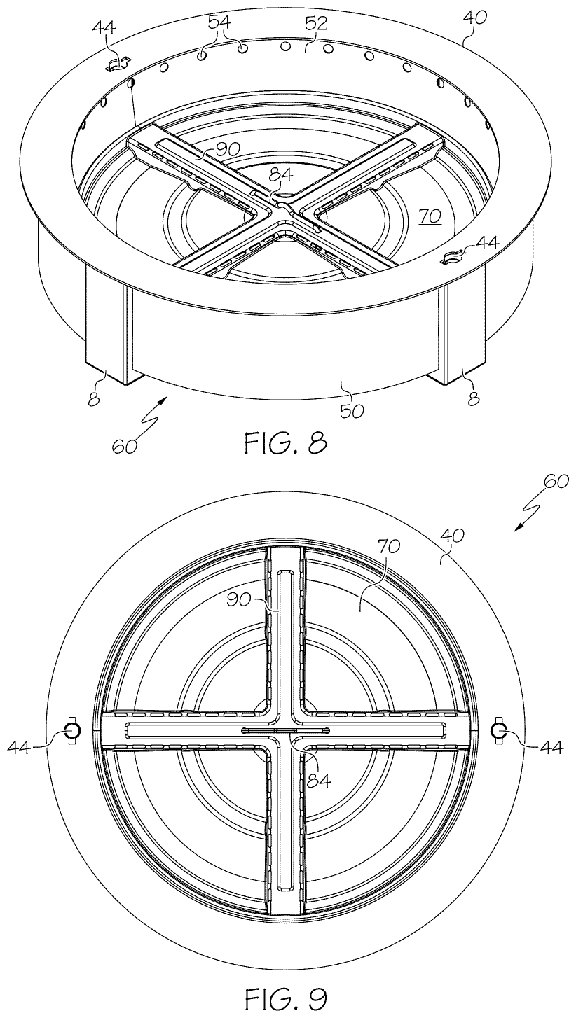

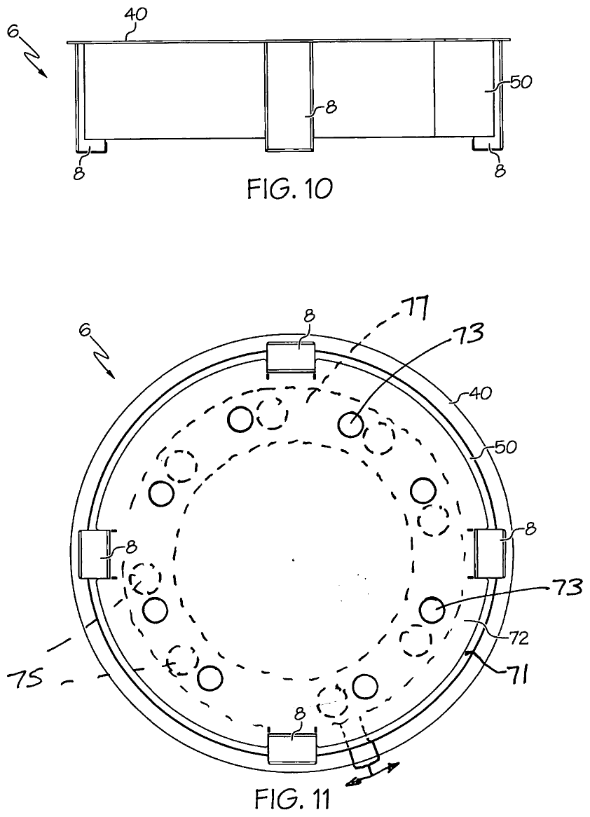

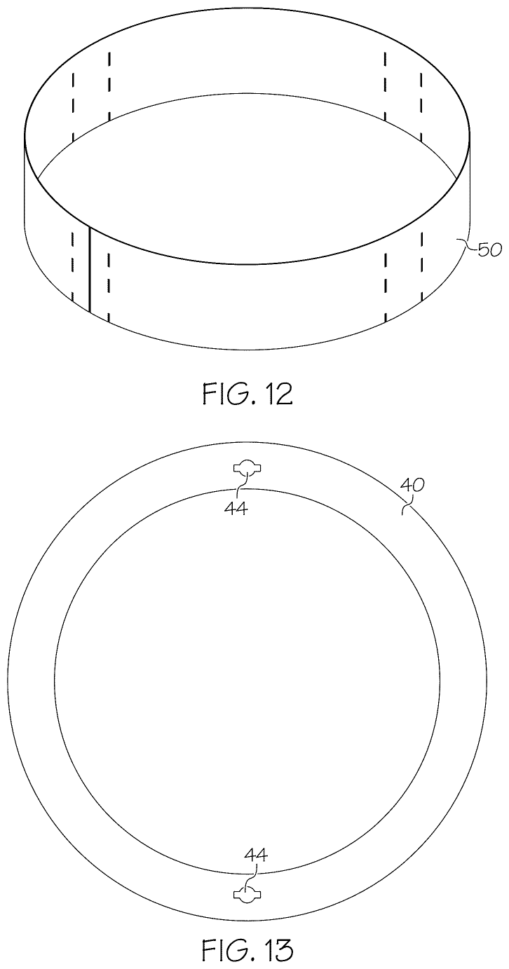

Stand 4 includes at least three legs 10. Four legs 10 are included in the exemplary configuration. The four legs 10 are located at the corners of stand 4. Upper 12 and lower 14 shelves are carried by legs 10. Upper shelf 12 is fixed or adjustable. Side panels 16 increase rigidity and protect items carried on shelves 12 and 14. An upper stand wall 18 is also carried by legs 10 below the area that receives fire tray 6. Cross member reinforcement beams 20 are located under one, some, or all of shelves 12, 14, and wall 18 (see example in FIG. 7).

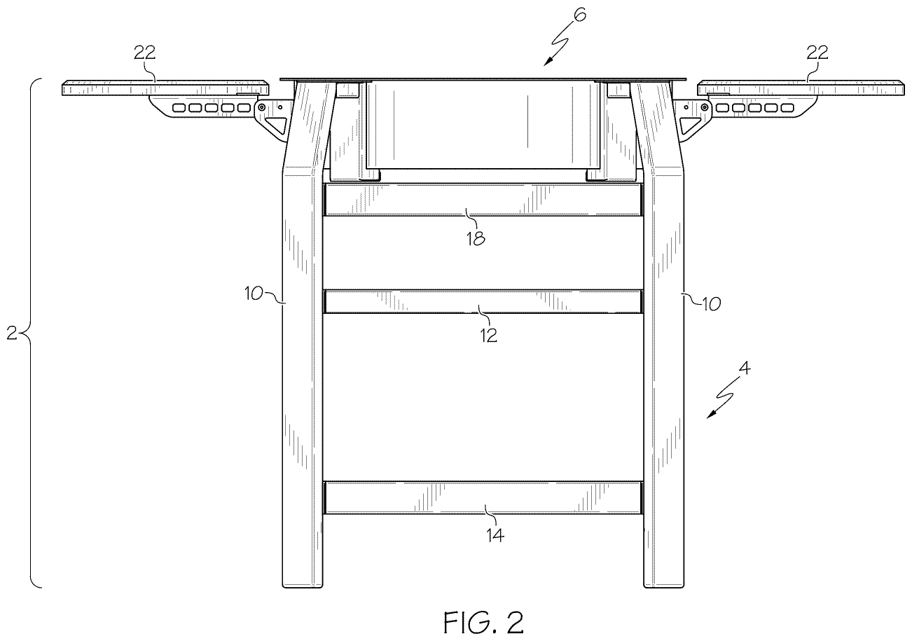

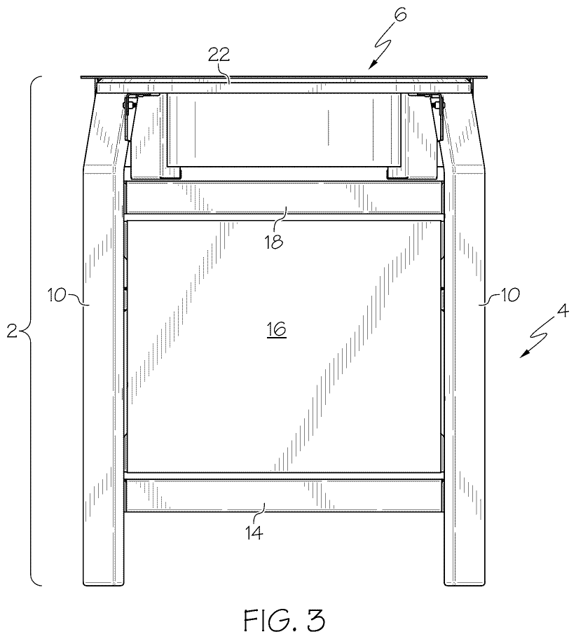

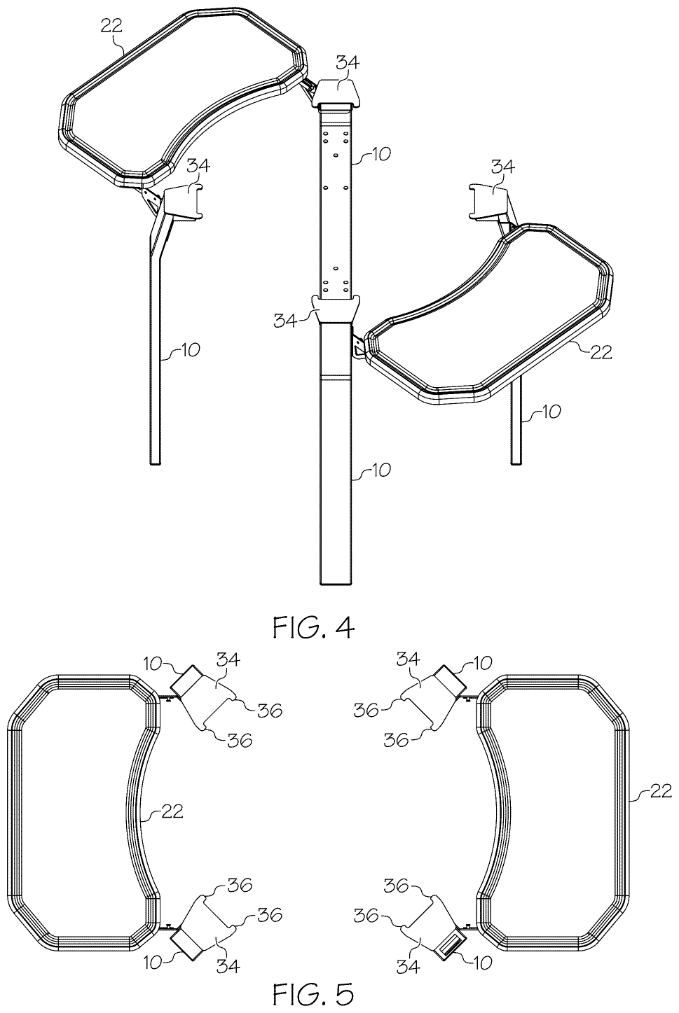

Trays 22 are carried on brackets that are connected to legs 10. As seen in FIG. 2, the brackets define openings that can be used to hang items from hooks such as cooking utensils. Trays 22 are located on opposite sides of apparatus 2. Each tray 22 can be moved between upright (depicted) and stored positions independently of the other tray 22. Each tray 22 includes one or more accessory tracks 24 (FIG. 7) along its bottom surface. Tracks 24 accommodate accessories such as hooks for holding cooking utensils.

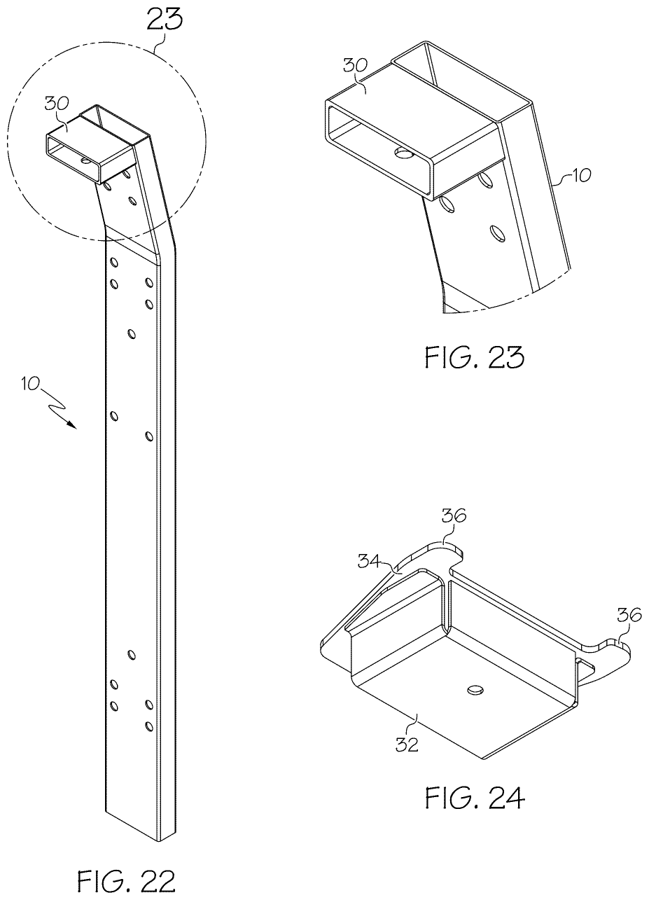

FIGS. 22 and 23 depict the top end of each leg 10. In the exemplary configuration of assembly 2, the upper portion of each leg is angled inwardly toward fire tray 6. In other configurations, legs 10 are straight. Each leg 10 is tubular and can be rectangular, oval, or circular in cross section. At the top end of each leg, a leg box 30 projects inwardly (toward fire tray 6 when leg is installed). Leg box 30 is also tubular and can match the cross section of leg 10. In the exemplary configuration, the bottom wall of each leg box 30 defines a fastener opening. Leg boxes 30 are received in a fire tray support box 32 (FIG. 24) and a fastener secures the two together. These also can be connected by a snap fit or with welds. Each fire tray support box 32 carries a fire tray support 34 that includes two spaced projections 36. Projections are located on opposite sides of legs 8 when fire tray 6 is carried by stand 4. At least projections 36 of support 34 are located under an upper wall 40 (in this exemplary configuration upper wall 40 is a ring-shaped upper wall 40) of fire tray 6 to support it above upper stand wall 18. Each support 34 also covers the open upper tube end of the leg 10 on which it is mounted.

This support configuration allows a user to lift fire tray 6 up through supports 34 away from stand 4. This configuration allows the user to use fire tray 6 to cook food in a comfortable raised position on stand 4. Cooking utensils can be used such as those that are connected to an accessory post such as that disclosed in U.S. Pat. No. 12,303,068 B2 which is incorporated herein by reference. This patent discloses a locking accessory post that is selectively received in a post holder 42 (FIG. 20) located below a post opening 44. The exemplary embodiment of fire tray 6 includes two post holders 42 on opposite sides so that multiple utensils can be used at the same time. Grills and griddles can be carried on the accessory posts. Fire tray also can have a grill or griddle supported by upper wall 40. An example of such a device is disclosed in U.S. patent D1,059,576 S which is incorporated herein by reference. Other cooking utensils such as rotisseries and hanging pots can be used. When the user is finished cooking, the user (alone or with the help of another person) can lift (using heat resistant gloves or tools) fire tray 6 from stand 4 and use it as a fire pit with legs 8 supporting fire tray 6 above its new support surface (the ground, a base, a table, or a heat resistant surface). When finished as a fire pit, fire tray 6 can be replaced in stand 4 for storage.

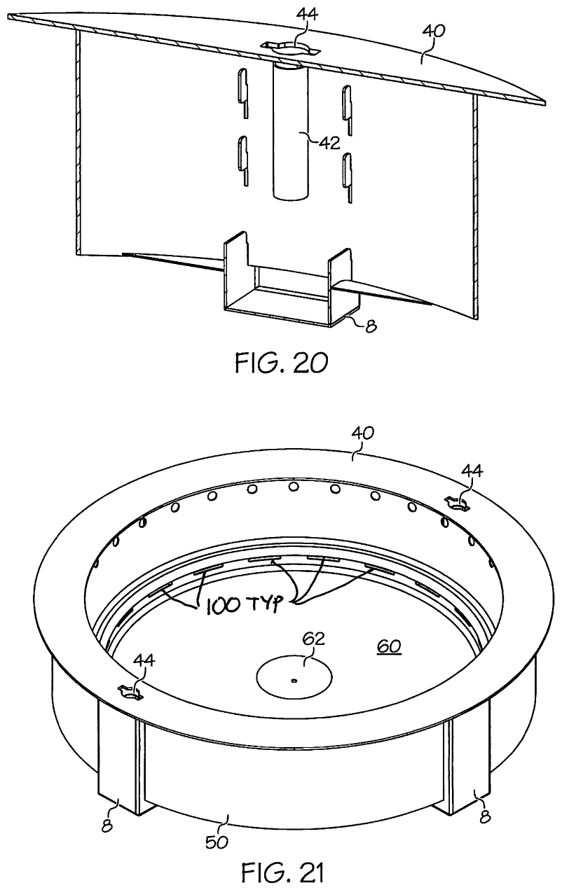

Fire tray 6 includes upper wall 40 that outwardly overhangs an outer sidewall 50 an inwardly overhangs an inner sidewall 52. An air inlet channel is defined between walls 50 and 52. Air is drawn into the channel and then output to the fire box through outlets 54 positioned near the top end of inner sidewall 52. A bottom wall 60 in combination with inner sidewall 52 defines the fire box for fire tray 6. Bottom wall 60 defines a recess with a drain 62 (FIG. 21). A removable ash tray 70 is located within the fire box and is carried by inner sidewall 52. A heat shield 72 (FIG. 11) is located below and spaced from bottom wall 60 and defines air openings between itself and outer sidewall 50 to allow air to reach the fire box. Legs 8 extend below heat shield 72. In the exemplary configuration depicted in FIG. 11, the outer perimeter edge of heat shield 72 is spaced from the inner surface of outer sidewall 50 to define an air inlet 71 around most of the perimeter of fire tray 6. In another configuration, heat shield 72 defines its own air inlets 73 that are used alone or in combination with air inlet 71. In both configurations, an adjustable damper 77 can be used to vary the percent of the air inlet that is open. An example of such a damper is a rotatable disc or ring of material that sits above heat shield 72 with an adjustment handle projecting out the front under outer sidewall 50. Movement of the handle rotates the rotatable ring 77 to cover a selected percentage of the air inlets. FIG. 11 depicts 100 percent closed with the openings 75 of damper 77 offset from air inlets 73.

Ash tray 70 has a continuous outer rim 80 that engages a shelf 82 defined by inner sidewall 52 to support ash tray 70 above bottom wall 60. Outer rim 80 has a maximum diameter that is less than the maximum diameter of the central opening of upper wall 40 so that ash tray 70 can be lifted upwardly out of the fire box. This allows ash to be easily removed from the fire box. A handle 84 is carried by ash tray 70. When not in use, handle 84 sinks down to a stored location. When lifted, the legs of handle 84 slide up through ash tray 70 until stops engage and hold handle 84 in an extended position that allows ash tray 70 to be lifted.

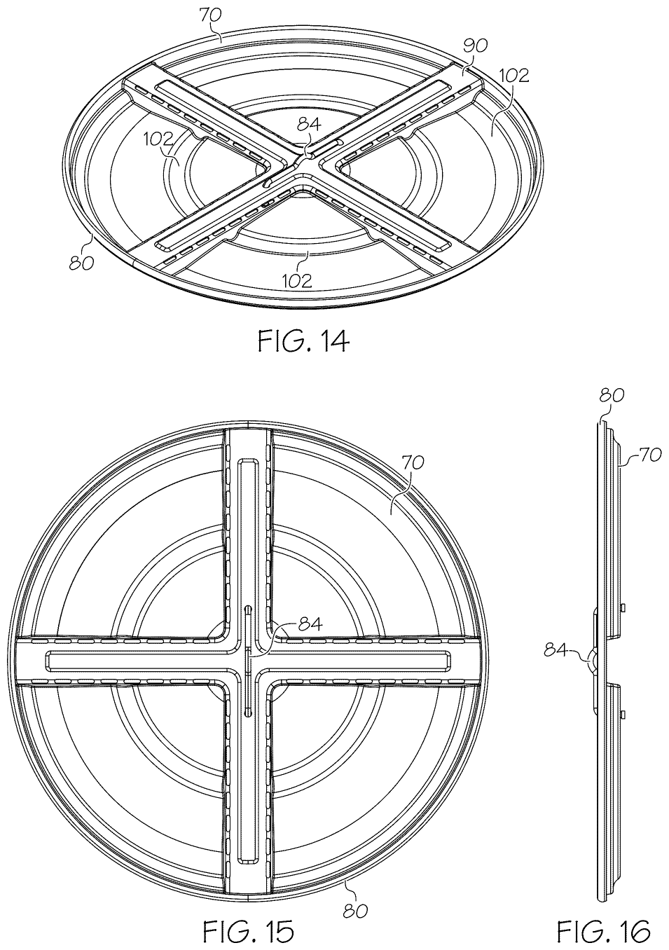

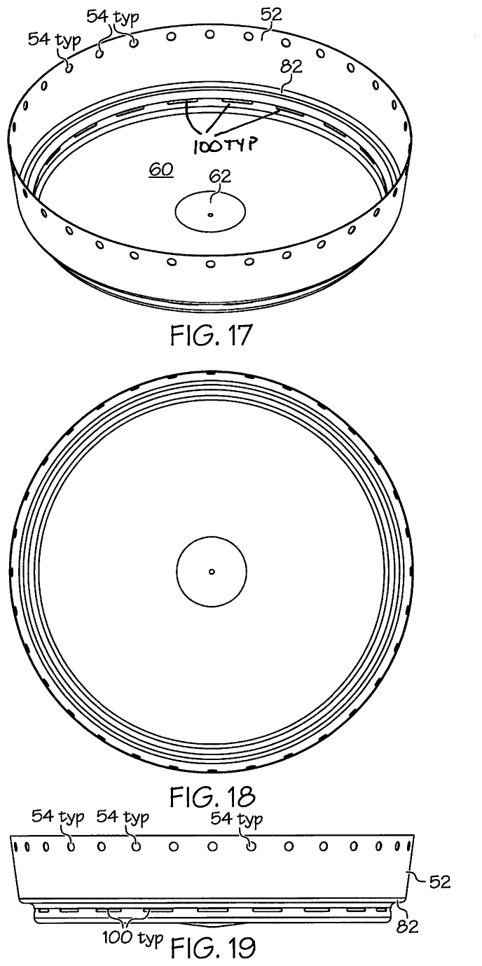

Ash tray 70 defines an inlet air manifold 90 that is raised above the lower surface of ash tray 70. Manifold 90 includes a plurality of hollow arms that each has an inner end (joined together at the center of ash tray 70), an outer end (that engages the inner portion of rim 80), opposed sidewalls, and a top wall. The bottom wall of ash tray 70 does not extend under the arms so that air can flow into arms from the chamber between ash tray 70 and bottom wall 60. Air openings are defined along the length of the arms at the bends of material between the sidewalls and the top wall. To supply air to manifold 90, inner sidewall 52 defines a plurality of air inlets 100 (FIGS. 17-19 and 21) that are under ash tray 70 when it is seated. Air inlets 100 draw air from the chamber below bottom wall 60 and above heat deflector 72. An adjustable damper is used to control the air flow through air inlets 100 in an exemplary configuration of the disclosure. In this configuration, a ring is carried outward of air inlets 100 and is selectively movable to cover percentages of air inlets 100.

Ash tray 70 defines at least one raised or depressed ring 102 that increases the rigidity of ash tray 70. The sidewalls of the manifold arms match the geometry of ring 102 or rings 102. In another embodiment, ash tray 70 can define drain holes in its lower wall such as in ring 102.

The fuel for the fire is burned on ash tray 70. The raised air inlets of manifold 90 reduced clogging and maintains an air supply from the air chamber below ash tray 70. This chamber, bottom wall 60, and heat deflector 72 work in combination to reduce the heat experienced by stand 4 when fuel is being burned on ash tray 70. The double sidewall structure and upper stand wall 18 also deflects heat from the fire box.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are examples and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps. Up, down, left, right, top, and bottom are in reference to the orientation of the drawings.

1. A grill apparatus comprising:
a fire tray removably carried by a stand; the fire tray having a plurality of fire tray legs, and outer sidewall, and an upper wall;
the stand having a plurality of stand legs; a plurality of the stand legs having a fire tray support;
the fire tray being slidably movable with respect to the fire tray supports between a cooking position wherein the upper wall of the fire tray engages the fir tray supports and a removable position wherein the outer sidewall is located at a position higher than the fire tray supports such that the fire tray can be removed from the stand.

2. The apparatus of claim 1, wherein the fire tray supports are disposed around portions of the fire tray legs.
